(19) United States
(12) Patent Application Publication
(10) Pub. No.: US 2026/0052227 A1
(43) Pub. Date: Feb. 19, 2026

(54) CUSTOMIZING VIRTUAL MEETING INVITES

(71) Applicant: Google LLC, Mountain View, CA (US)

(72) Inventors: Pablo Federico Majernik, Sammamish, WA (US); Evan Smithers, Portland, OR (US); Juan Carlos Angustia Garcia, Philadelphia, PA (US); Kimberly Ha, Seattle, WA (US); Ricardo Paz, San Jose, CA (US)

(21) Appl. No.: 18/807,588

(22) Filed: Aug. 16, 2024

(51) Int. Cl. H04N 7/15

(52) U.S. Cl. CPC H04N 7/157; H04N 7/152

(57) ABSTRACT

A method for customizing virtual meeting invites includes receiving, at a virtual meeting platform, a first custom media item provided by a first user of a virtual meeting between one or more participants. The one or more participants may include the first user. The method includes generating a customized virtual meeting invite for the virtual meeting. The customized virtual meeting invite may include the first custom media item provided by the first user and a reference to the virtual meeting. The method includes causing the customized virtual meeting invite to be provided to the one or more participants. The method includes, responsive to obtaining an indication of a participant of the one or more participants interacting with the reference to the virtual meeting of the customized virtual meeting invite, instantiating the virtual meeting.

### TECHNICAL FIELD

Aspects and implementations of the present disclosure relate to virtual meetings and more specifically to customizing virtual meeting invites.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video streams (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method. The method includes receiving, at a virtual meeting platform, a first custom media item provided by a first user of a virtual meeting between one or more participants. The one or more participants may include the first user. The method includes generating a customized virtual meeting invite for the virtual meeting. The customized virtual meeting invite may include the first custom media item provided by the first user and a reference to the virtual meeting. The method includes causing the customized virtual meeting invite to be provided to the one or more participants. The method includes, responsive to obtaining an indication of a participant of the one or more participants interacting with the reference to the virtual meeting of the customized virtual meeting invite, instantiating the virtual meeting.

Another aspect of the disclosure provides a system. The system includes a memory and a processing device coupled to the memory. The processing device is configured to perform one or more operations. The operations include receiving, at a virtual meeting platform, a first custom media item provided by a first user of a virtual meeting between one or more participants. The one or more participants may include the first user. The operations include generating a customized virtual meeting invite for the virtual meeting. The customized virtual meeting invite may include the first custom media item provided by the first user and a reference to the virtual meeting. The operations include causing the customized virtual meeting invite to be provided to the one or more participants. The operations include, responsive to obtaining an indication of a participant of the one or more participants interacting with the reference to the virtual meeting of the customized virtual meeting invite, instantiating the virtual meeting.

Another aspect of the disclosure provides a non-transitory computer-readable storage medium with instructions that, when executed by a processing device, cause the processing device to perform one or more operations. The operations include receiving, at a virtual meeting platform, a first custom media item provided by a first user of a virtual meeting between one or more participants. The one or more participants may include the first user. The operations include generating a customized virtual meeting invite for the virtual meeting. The customized virtual meeting invite may include the first custom media item provided by the first user and a reference to the virtual meeting. The operations include causing the customized virtual meeting invite to be provided to the one or more participants. The operations include, responsive to obtaining an indication of a participant of the one or more participants interacting with the reference to the virtual meeting of the customized virtual meeting invite, instantiating the virtual meeting.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for customizing virtual meeting invites, in accordance with some implementations of the present disclosure.

FIG. 2 depicts an example flow diagram of a method for customizing virtual meeting invites, in accordance with some implementations of the present disclosure.

FIG. 3 depicts an example user interface (UI) for generating a customized virtual meeting invite, in accordance with some implementations of the present disclosure.

FIG. 4 depicts an example UI for a customized virtual meeting invite, in accordance with some implementations of the present disclosure.

FIG. 5 depicts an example UI for a virtual meeting initiated from a customized virtual meeting invite, in accordance with some implementations of the present disclosure.

FIG. 6 depicts an example UI for a calendar application that includes a customized virtual meeting invite, in accordance with some implementations of the present disclosure.

FIG. 7 is a block diagram illustrating an example computer system, in accordance with some implementations of the present disclosure.

### DETAILED DESCRIPTION

Aspects of the present disclosure relate to customizing virtual meeting invites. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

Conventionally, a user organizing or hosting a virtual meeting sends virtual meeting invites to other users. The virtual meeting invites typically include information about the date and time of the virtual meeting and data used to access the virtual meeting (e.g., a uniform resource locator (URL) used to access the virtual meeting). As such, typical virtual meeting invites are static and not engaging for the recipient users. Furthermore, when users receive such a meeting invite, they usually cannot derive much information from the invite itself and have to open a calendar application and click through it in order to decide whether to accept it, which takes time and results in consumption of additional computing resources.

Implementations of the present disclosure address the above and other deficiencies by providing a platform for virtual meeting users to customize their virtual meeting invites with custom media items, such as images, videos, audio, themes, and other data. The customized virtual meeting invites can then be sent to invitees of the virtual meeting so the invitees can view, listen to, and otherwise interact with the custom media items. The customized virtual meeting invites make the virtual meeting invites more engaging for the receiving users. This improves the virtual meeting experience of the receiving users. In addition, a customized virtual meeting invite conveys information about a virtual meeting, allowing a recipient user to decide whether to accept the invite just by glancing at the invite and without needing to open a calendar application, thereby resulting in reduction of computing resources.

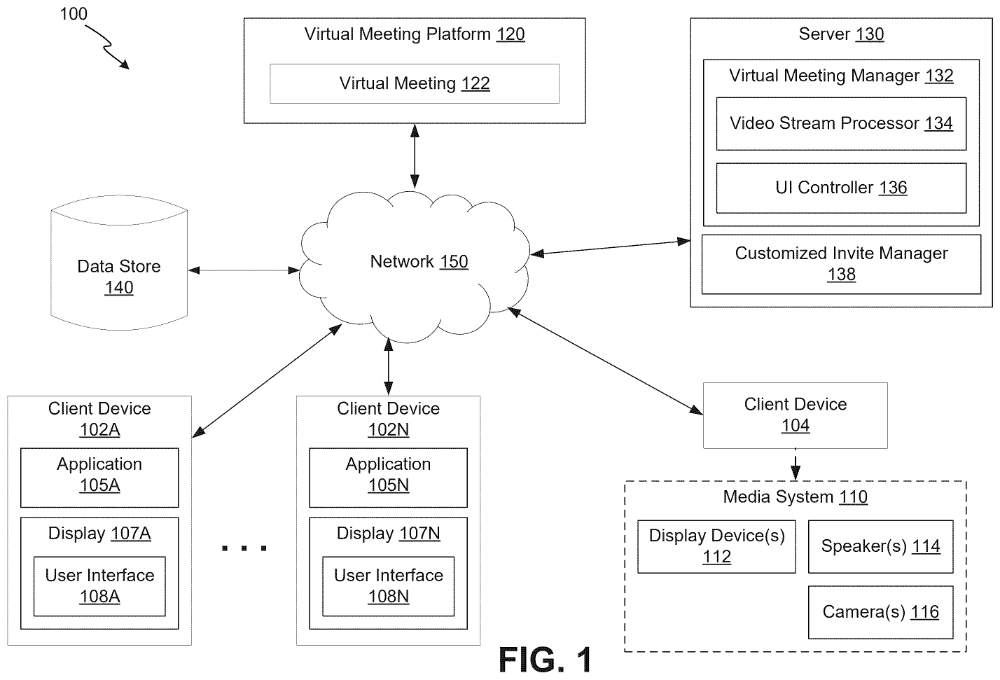

FIG. 1 illustrates an example system architecture 100, in accordance with implementations of the present disclosure. The system architecture 100 includes one or more client devices 102A-N or 104, a virtual meeting platform 120, a server 130, and a data store 140, each connected to a network 150.

In some implementations, the virtual meeting platform 120 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured to manage a virtual meeting 122 between multiple users of the virtual meeting platform 120. The virtual meeting manager 132 can provide the UIs 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-107N by the client applications 105A-N executing on the operating systems of the client devices 102A-N, 104. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 can be configured to receive video streams from one or more of the client devices 102A-N, 104. The video stream processor 134 can be configured to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the video stream processor 134 receives audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. Each region can display a video stream pertaining to one or more participants of the virtual meeting 122. The UI controller 136 can control which video stream is to be displayed by providing a command to one or more client devices 102A-N, 104 that indicates which video stream is to be displayed in which region of the UI (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

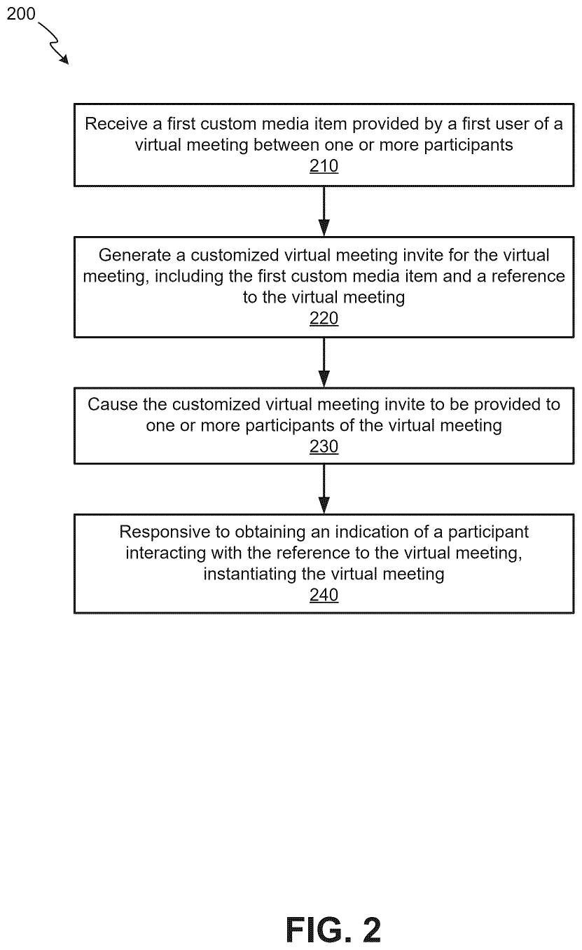

In one or more implementations, the virtual meeting manager 132 includes a customized invite manager 138. The customized invite manager 138 may include a software application (or a subset thereof) that performs certain virtual meeting functionality for the virtual meeting manager 132. The customized invite manager 138 can be configured to obtain custom media items from a first user of a virtual meeting 122, generate a customized virtual meeting invite that includes the custom media items and a reference to the virtual meeting, and causes the customized virtual meeting invite to be provided to one or more invitees of the virtual meeting 122. Functionality of the customized invite manager 138 is discussed further below in relation to FIG. 2.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 can be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 150). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-N, the one or more client devices 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107-107N of a client device 102A-N or a UI (e.g., a UI of the UIs 108A-N), one or more features of the application 105A-N for users to access the virtual meeting platform 120. For example, a user of client device 102A can join and participate in the virtual meeting 122 via a UI 108A presented on the display device 107A by the application 105A. The user can present a document to participants of the virtual meeting 122 using the UI 108A. Each of the UIs 108A-N can include multiple regions to present visual items corresponding to video streams of the client devices 102A-N provided to the server 130 for the virtual meeting 122.

In one or more implementations, the customized invite manager 138 is part of a client device 102A-N, 104. For example, the application 105A-N can include the customized invite manager 138, which can obtain custom media items, generate a customized virtual meeting invite, and cause the customized virtual meeting invites to be sent to invitees of the virtual meeting 122 (which may include users of the client devices 102A-N, 104). In some implementations, the application 105A sends the video stream to the other client devices 102B-N, 104, and receives the video streams from the other client devices 102B-N, 104, and the applications 105A-105N can generate their respective virtual meeting UIs 108A-N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for customizing virtual meeting invites, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the customized invite manager 138 performs one or more of the operations of the method 200.

At block 210, processing logic receives a first custom media item provided by a first user of a virtual meeting 122 between one or more participants. The one or more participants of the virtual meeting 122 may include the first user. The virtual meeting 122 may include a virtual meeting that has not yet been initialized or otherwise organized during block 210. The first user may include the host or organizer of the virtual meeting 122. In one implementation, the customized invite manager 138 receives the first custom media item.

In some implementations, the first custom media item includes image data. The image data may include an image file. The image data may include a static image file (e.g., a JPEG file) or an animated image file (e.g., a GIF or WebM file). In one implementation, the first custom media item includes video data. The video data may include a video file. The first custom media item may include audio data. The audio data may include an audio file. In one or more implementations, the first custom media item includes text data. The text data may include one or more strings of text. The text data may include data indicating a size, font, color, a style (e.g., bold, italics, underline, strikethrough, etc.) of the strings of text. In some implementations, the first custom media item may include a reference to image, video, audio, or text data stored on a computing device other than the client device 102A-N, 104 of the first user (e.g., a cloud storage platform).

In one implementation, the first custom media item includes a theme. A theme may include data that indicates one or more presentation, style, or visual elements of a customized virtual meeting invite. The theme may include data that indicates a font, size, color, or style of text included in the customized virtual meeting invite. The theme may include a background of the invite, and the background may include images, patterns, or other visual elements. The theme can indicate a layout of the components of the invite. The theme can indicate, to a recipient of the customized virtual meeting invite, an identity of the first user (e.g., by using visual elements associated with the first user).

In one implementation, the first user can use a customized virtual meeting invite UI to provide the first custom media item. The first user can interact with the customized virtual meeting invite UI to provide the first custom media item, input information about the virtual meeting 122 (e.g., start and end date, start and end time, a reference to the virtual meeting, etc.), or perform other functions to organize the virtual meeting 122. The customized virtual meeting invite UI can be a UI of an application which can provide the input data, including the first custom media item, to the customized invite manager 138. The application can be the application 105A-N, the customized invite manager 138, a calendar application (e.g., the customized virtual meeting invite UI can be provided by a plugin to the calendar application), etc.

In some implementations, receiving the first custom media item includes receiving a file or other computing resource that includes the first custom media item. For example, the first user can upload the file or computing resources that includes the first custom media item to the customized invite manager 138. In other implementations, receiving the first custom media item includes receiving a reference to the file or other computing resource that includes the first custom media item. The file or computing resource may include a file or computing resource stored on a cloud storage platform, on a server (other than the server 130), or on some other computing device. The reference to the file or other computing resource can allow an application that presents the customized virtual meeting invite to access the file or computing resource in order to render the first custom media item.

At block 220, processing logic generates a customized virtual meeting invite for the virtual meeting 122. The customized virtual meeting invite may include the first custom media item provided by the first user. The customized virtual meeting invite may include a reference to the virtual meeting 122.

The customized virtual meeting invite may include data that stores scheduling information for the virtual meeting 122, one or more custom media items (e.g., the first custom media item), a reference to the virtual meeting 122, or other information that the application 105A-N or another application can use to display information about the virtual meeting 122, access the virtual meeting 122, or perform other functionality related to the virtual meeting 122.

In one implementation, the customized virtual meeting invite includes a calendar invite. A calendar invite may include a file or other computing resource type that allows a user to store and exchange calendaring and scheduling information for a calendar event stored by a calendar application. A calendar application may include a software application (or a subset thereof) that performs calendar functionality. The calendar application can provide a digital calendar to a user and allow the user to organize a calendar event, send a calendar invite associated with the calendar event to one or more other users, or perform other calendar functions. The calendar application may include an application executing on a client device 102A-N, 104 or a web or cloud-based calendar application that the client device 102A-N, 104 accesses through an application on the client device 102A-N, 104 (e.g., a web browser or mobile application). A calendar event may include data that includes information about an event scheduled in the calendar of the calendar application. The calendar event may include information indicating a start and/or end date of the event, a start and/or end time, a location of the event, or other information regarding the event. The calendar application can add a calendar event corresponding to a calendar invite to the user's calendar.

In some implementations, the customized virtual meeting invite includes a data file or other computing resource type that is compatible with the application 105A-N. The customized virtual meeting invite being compatible with the application 105A-N may include the application 105A-N recognizing the format of the invite and being configured to parse the invite to obtain and process data stored by the invite. In one or more implementations, the customized virtual meeting invite includes data stored in a cloud storage that is accessible by the application 105A-N of a user invited to the virtual meeting 122.

In some implementations, the reference to the virtual meeting 122 that is included in the customized virtual meeting invite may include data used to access the virtual meeting 122. The data used to access the virtual meeting may include a reference to a web resource (e.g., a link, a URL, etc.) or other data that the application 105A-N can use to join the virtual meeting 122.

In one implementation, the first custom media item is stored on a cloud storage platform. The customized virtual meeting invite including the first custom media item may include the customized virtual meeting invite including a reference to access the first custom media item in the cloud storage platform. The reference may include a link, URL, or other reference that a receiving application can use to access the first custom media item and render the first custom media item on a UI so a receiving participant can view the customized virtual meeting invite.

At block 230, processing logic causes the customized virtual meeting invite to be provided to one or more participants of the virtual meeting 122. In one implementation, providing the customized virtual meeting invite to the one or more participants includes the virtual meeting platform 120, the server 130, the customized invite manager 138, or some other computing device or component sending the customized virtual meeting invite to the one or more participants. In some implementations, providing the customized virtual meeting invite to the one or more participants includes the application 105A-N of the client devices 102A-N, 104 sending the customized meeting invite to the one or more participants (which can be in response to an instruction provided by the customized invite manager 138).

In one implementation, causing the customized virtual meeting invite to be provided to the one or more participants includes causing a calendar invite that includes the customized virtual meeting invite to be sent to the one or more participants. Sending the calendar invite may include sending a calendar invite file in an email.

In some implementations, providing the customized virtual meeting invite to the one or more participants includes the virtual meeting platform 120, the server 130, the customized invite manager 138, or another computing device or component causing a text message to be sent to the one or more participants. The text message may include a Rich Communication Services (RCS) text message or a text message that complies with another communication protocol. An RCS text message may include a text message configured to include image or video data renderable by a RCS-compatible application. The RCS application may include RCS features such as file sharing, typing indicators, read receipts, or other RCS features.

In one implementation, providing the customized virtual meeting invite to the one or more participants includes the virtual meeting platform 120, the server 130, the customized invite manager 138, or another computing device or component causing a virtual meeting application to send data that includes the customized virtual meeting invite to the one or more participants of the virtual meeting 122. The virtual meeting application may include a mobile application on a client device 102A-N, 104 that performs virtual meeting functionality (e.g., joining a virtual meeting 122, displaying a virtual meeting UI with video and/or audio streams of other participants of the virtual meeting 122, etc.). In some implementations, the application 105A-N includes the virtual meeting application. The virtual meeting application may include a cloud application or cloud service that performs virtual meeting functionality and that users can access using a web browser or mobile application. The data that includes the customized virtual meeting invite may include data in a format compatible with the virtual meeting application.

In one or more implementations, the customized virtual meeting invite includes data that can identify the one or more participants of the virtual meeting 122. The first user can provide the data that identifies the one or more participants when providing the first custom media item or other data used to generate the customized virtual meeting invite. The data that identifies the one or more participants may include email addresses of the participants, telephone numbers of the participants, usernames of the participants (e.g., usernames for use with the virtual meeting platform 120), or other identifying data. The customized invite manager 138 can use the data that identifies the one or more participants to cause the customized virtual meeting invite to be provided to the one or more participants.

At block 240, responsive to obtaining an indication of a participant of the one or more participants interacting with the reference to the virtual meeting 122 of the customized virtual meeting invite, processing logic initiates the virtual meeting 122. The one or more participants can receive the customized virtual meeting invite. In one implementation, where the customized virtual meeting invite is sent via an email, an email application used by a participant receives the email. The participant can use the client device 102B-N, 104 to interact with an application (e.g., a mobile application or web browser) to access the email application and open the email. Responsive to opening the email, the application can display the customized virtual meeting invite. Displaying the customized virtual meeting invite may include displaying the scheduling information of the invite, the first custom media item, and other data associated with the invite.

In some implementations, where the customized virtual meeting invite is sent via a text message, a text message application used by a participant receives the text message. The participant can use the client device 102B-N, 104 to interact with the text message application to open the text message. Responsive to opening the text message, the text message application can display the customized virtual meeting invite.

In one or more implementations, where the customized virtual meeting invite is included in a data file compatible with a virtual meeting application, the virtual meeting application used by the participant receives the data file. The participant can use the client device 102B-N, 104 to interact with an application (e.g., the application 105B-N or a web browser) to access the virtual meeting application and open the customized virtual meeting invite. Responsive to opening the invite, the application 105B can display the customized virtual meeting invite. The data file can be configured to cause a presentation of a notification on the client device 102B-N, 104 responsive to the application 105B-N receiving the data file. The notification may include a push notification or another type of notification displayable on the client device 102B-N, 104.

In some implementations, the customized virtual meeting invite is configured to be saved to a calendar application as a calendar event. Responsive to a participant interacting with the calendar event (e.g., by interacting with a calendar application UI), the calendar application can display the first custom media item.

As discussed above, the client device 102B-N, 104 can display the customized virtual meeting invite, which can include displaying a calendar event generated by a calendar application in response to receiving the customized virtual meeting invite. The participant using the client device 102B-N, 104 can view the customized virtual meeting invite, which may include viewing the first custom media item. Viewing the first custom media item can improve the participant's experience when using virtual meeting functionality. For example, as discussed above, the customized virtual meeting invite may include a theme that can indicate an identity of the first user to the viewing participant. In another example, the customized virtual meeting invite may include one or more images or videos that provide information about or context for the virtual meeting 122, which can be difficult to communicate using a conventional virtual meeting invite. The customized virtual meeting invite may include audio that can be played from the invite to provide music or other enjoyable sound to the participant.

Also as discussed above, the customized virtual meeting invite may include a reference to the virtual meeting 122, which may include data that the application 105B-N can use to access the virtual meeting 122. The customized virtual meeting invite, when displayed on the client device 102B-N, 104, may include a UI element that the participant using the client device 102B-N, 104 can interact with in order to cause the application 105B-N to access the virtual meeting 122. Responsive to the participant interacting with the UI element, the application 105B-N can send an indication of the participant interacting with the reference to the virtual meeting 122 to the virtual meeting platform 120 or the server 130. The virtual meeting platform 120 or the server can instantiate the virtual meeting 122.

Instantiating the virtual meeting 122 may include the virtual meeting platform 120 starting the virtual meeting 122. Instantiating the virtual meeting 122 may include the virtual meeting platform 120 or the virtual meeting manager 132 causing the application 105B-N of the participant that sent the indication to join the virtual meeting 122. Instantiating the virtual meeting 122 may include the virtual meeting platform 120 or the virtual meeting manager 132 causing the application 105B-N of the participant that sent the indication to otherwise connect to the virtual meeting 122. The participant can then participate in the virtual meeting 122.

In some implementations, the first user can update the customized virtual meeting invite with one or more custom media items that can differ from the first custom media item. The first user can update the customized virtual meeting invite because the first custom media item can be out of date or to give variety to the customized virtual meeting invite (e.g., wherein the customized virtual meeting invite is an invite to a reoccurring virtual meeting 122). In one implementation, the customized invite manager 138 receives a second custom media item provided by the first user. The second custom media item can be different from the first custom media item.

Receiving the second custom media item may include functionality similar to block 210 of the method 200. For example, the first user can use a customized virtual meeting invite UI to provide the second custom media item. The first user can use the customized virtual meeting invite UI to modify the customized virtual meeting invite. For example, the application 105A can provide a list of virtual meetings 122 generated by the first user, the user can select the virtual meeting 122 that corresponds to the customized virtual meeting invite, and, in response, the application 105A can instantiate the customized virtual meeting invite UI to modify the customized virtual meeting invite. In another example, the first user can use a calendar application to open the calendar event that corresponds to the customized virtual meeting invite, and the first user can use a calendar application UI to modify the calendar event. A plugin to the calendar application can provide the calendar application with the functionality to modify the calendar event with the second custom media item.

The customized invite manager 138 can update the customized virtual meeting invite to include the second custom media item. In one implementation, the customized invite manager 138 can cause the modified customized virtual meeting invite to be provided to one or more participants of the virtual meeting 122, which may include functionality similar to block 230 of the method 200.

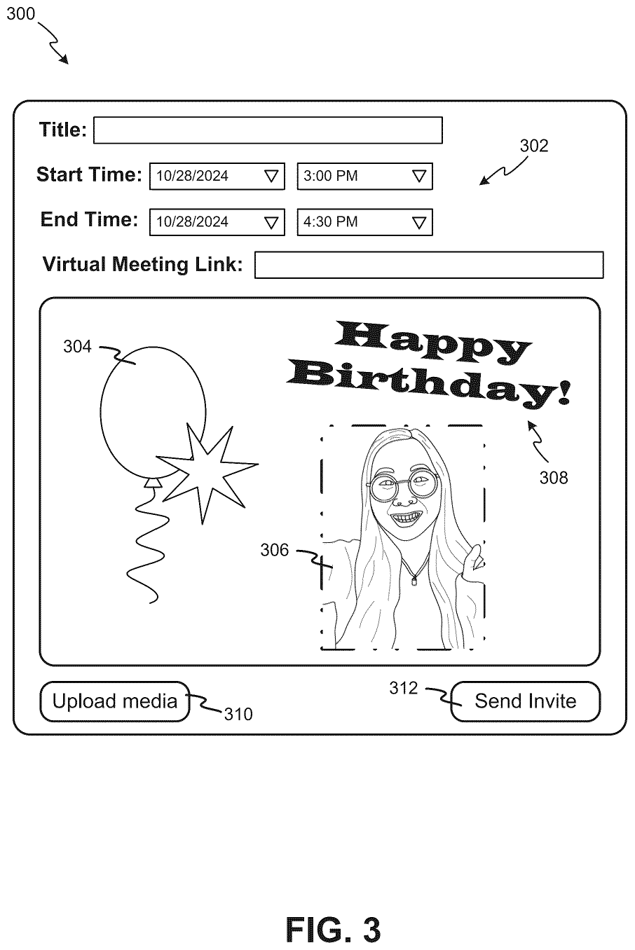

FIG. 3 depicts an example UI 300 for generating a customized virtual meeting invite, in accordance with some implementations of the present disclosure. The UI 300 may include a UI of the application 105A-N. The UI 300 may include one or more UI elements 302 that the first user can interact with to input or select scheduling information for the virtual meeting 122 and/or the reference to the virtual meeting 122. For example, as seen in FIG. 3, the UI elements 302 may include textboxes and dropdown boxes where the first user can input or select a title for the virtual meeting 122, start and end times and dates for the virtual meeting, identifiers for the one or more participants of the virtual meeting 122, and/or a reference to the virtual meeting 122.

In some implementations, the UI 300 may include one or more custom media items 304-308. For example, as seen in FIG. 3, a custom media item may include an image 304, a video 306, or text 308. The first user can provide a custom media item 304-308 to the UI by interacting with a UI element 310 (e.g., a button) to upload a file that contains the custom media item 304, input a reference to the custom media item 304-308, or the like. The first user can interact with the custom media items 304-308 to move them to different positions or orientations in the customized virtual meeting invite, resize the custom media items 304-308, or otherwise rearrange the custom media items 304-308. Responsive to the first user interacting with a UI element 312 indicating that the first user has finished the customized virtual meeting invite, the customized invite manager 138 can generate the customized virtual meeting invite and cause it to be provided to the one or more participants of the virtual meeting 122.

In some implementations, after the customized invite manager 138 has caused the customized virtual meeting invite to be provided to the one or more participants of the virtual meeting 122, the first user can use a UI similar to the UI 300 to modify the customized virtual meeting invite, as discussed above. Responsive to the first user interacting with the UI element 312, the customized invite manager 138 can cause the modified customized virtual meeting invite to be provided to the one or more participants of the virtual meeting 122.

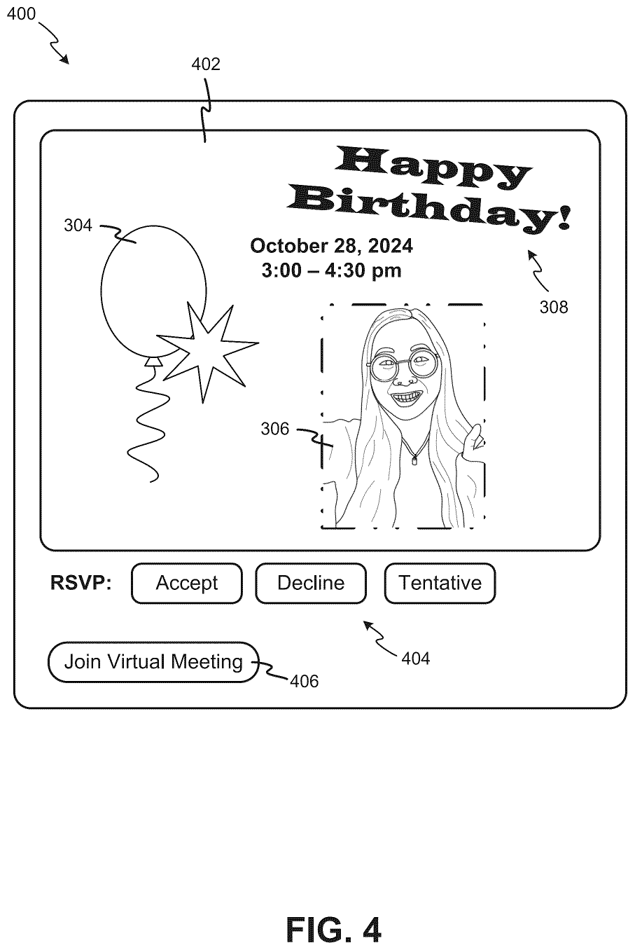

FIG. 4 depicts an example UI 400 for a customized virtual meeting invite, in accordance with some implementations of the present disclosure. The UI 400 may include a UI of an application 105A-N, a UI of a calendar application (e.g., a UI that opens in response to the calendar application receiving the customized virtual meeting invite), or the UI of some other application. The UI 400 may include a visualization 402 of the customized virtual meeting invite. The visualization 402 may include the one or more custom media items 304-308. The visualization 402 may include scheduling information for the virtual meeting 122, or the scheduling information can be displayed elsewhere in the UI 400. The UI 400 may include one or more UI elements 404 (e.g., buttons) that allow a recipient of the customized virtual meeting invite to send data to the first user indicating that the recipient intends to attend the virtual meeting 122, does not intend to attend the virtual meeting 122, can attend the virtual meeting 122, or to indicate some other attendance response. In some implementations, the UI 400 includes a UI element 406 that the recipient of the customized virtual meeting invite can interact with to access the reference to the virtual meeting 122 and join the virtual meeting 122.

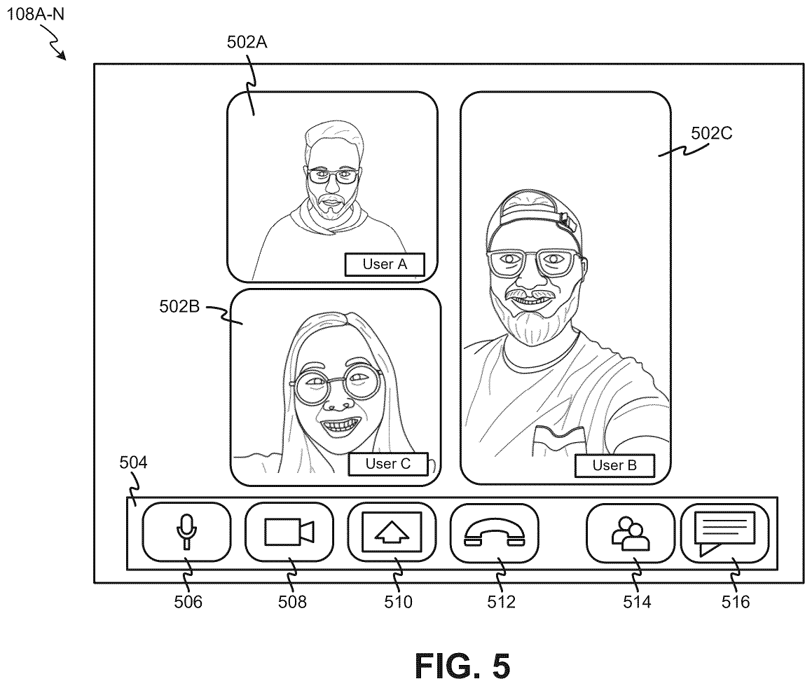

FIG. 5 depicts an example UI 108A-N for a virtual meeting initiated from a customized virtual meeting invite, in accordance with some implementations of the present disclosure. For example, in response to a recipient of the customized virtual meeting invite interacting with the UI element 406 of FIG. 4, the application 105A-N of the client device 102A-N, 104 of the recipient can connect to the virtual meeting 122 and initialize the UI 108A-N. The virtual meeting UI 108A-N may include one or more regions 502A-C corresponding to a visual item of the virtual meeting 122, such as a video stream provided by a client device 102A-N, 104 of a participant of the virtual meeting 122. The virtual meeting UI 108A-N can include a toolbar 504 that includes one or more UI elements configured to perform virtual meeting operations. For example, as seen in FIG. 5, the toolbar 504 includes an audio control button 506 used to mute and unmute a participant's audio stream, a camera control button 508 used to mute and unmute a participant's video stream, a screen share button 510 used to share a participant's client device's 102A-N, 104 screen with other participants of the virtual meeting 122, and a disconnect button 512 used to leave or disconnect from the virtual meeting 122. The toolbar 504 may include a participants button 514 that can display a list of the one or more participants of the virtual meeting 122. The toolbar 504 may include a chat button 516 that may display a chat interface that allows participants of the virtual meeting 122 to send and receive chat messages in the virtual meeting 122.

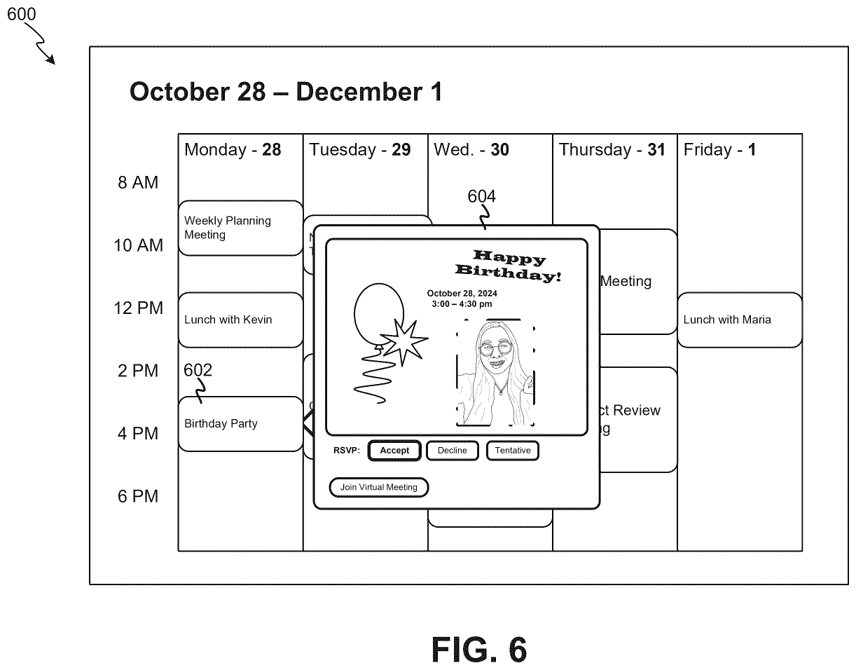

FIG. 6 depicts an example UI 600 for a calendar application that includes a customized virtual meeting invite, in accordance with some implementations of the present disclosure. The UI 600 may include UI elements corresponding to one or more days of a week and one or more times during the day. For example, as seen in FIG. 6, the UI 600 includes five column UI elements corresponding to the days Monday, Tuesday, Wednesday, Thursday, and Friday of a week. As can also be seen in FIG. 6, the UI 600 may include times of the day along a left side of the UI 600. Where a day column and a time intersect, the UI 600 may include a UI element corresponding to a calendar event scheduled for that day and time. For example, as seen in FIG. 6, the UI 600 includes a calendar event 602 scheduled for Monday from 3:00 to 4:30 p.m. entitled “Birthday Party.”The calendar event 602 may include a calendar event generated in response to receiving a customized virtual meeting invite. Responsive to a user of the calendar application interacting with the calendar event 602, the calendar application can display a UI 604 that includes the customized virtual meeting invite. The UI 604 may include one or more elements of the UI 400 of FIG. 4 (e.g., the custom media items, UI elements to indicate an attendance status of the recipient, or a UI element to access the reference to the virtual meeting 122).

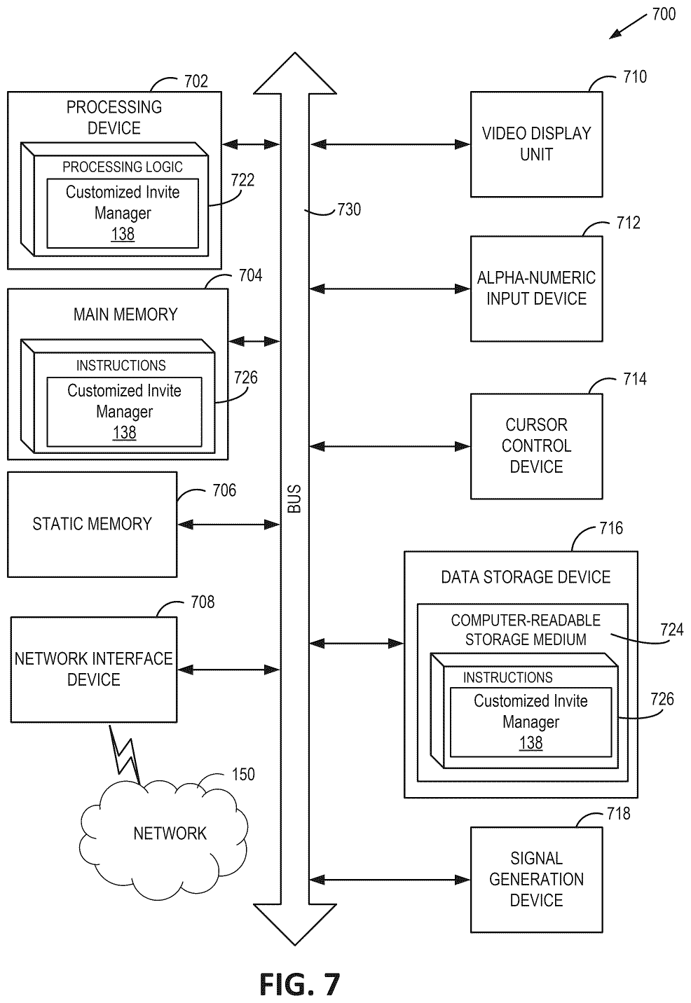

FIG. 7 is a block diagram illustrating an example computer system, in accordance with implementations of the present disclosure. The computer system 700 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 730.

The processing device 702 represents one or more general-purpose processing devices such as a microprocessor, central processing unit, or the like. More particularly, the processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute the processing logic 722 for performing the operations discussed herein (e.g., the operations of the customized invite manager 138).

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (sometimes referred to as a “computer-readable storage medium”) on which is stored one or more sets of instructions 726 (e.g., the instructions to carry out one or more operations of the customized invite manager 138) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over the network 150 via the network interface device 708.

In one implementation, the instructions 726 include instructions for determining visual items for presentation in a user interface of a virtual meeting. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
receiving, at a virtual meeting platform, a first custom media item provided by a first user of a virtual meeting between a plurality of participants, the plurality of participants comprising the first user;
generating a customized virtual meeting invite for the virtual meeting, wherein the customized virtual meeting invite comprises:
the first custom media item provided by the first user, and
a reference to the virtual meeting;
causing the customized virtual meeting invite to be provided to one or more participants of the plurality of participants; and
responsive to obtaining an indication of a participant of the one or more participants interacting with the reference to the virtual meeting of the customized virtual meeting invite, instantiating the virtual meeting.

2. The method of claim 1, wherein the first custom media item comprises at least one of:
image data;
video data; or
audio data.

3. The method of claim 1, wherein the customized virtual meeting invite comprises at least one of:
a calendar invite file; or
a data file configured to cause a presentation of a notification on a client device.

4. The method of claim 1, wherein:
the first custom media item is stored on a cloud storage platform; and
the customized virtual meeting invite comprising the first custom media item includes the customized virtual meeting invite comprising a reference to access the first custom media item in the cloud storage platform.

5. The method of claim 1, wherein the reference to the virtual meeting comprises a link to the virtual meeting.

6. The method of claim 1, further comprising:
receiving, at the virtual meeting platform, a second custom media item provided by the first user; and
updating the customized virtual meeting invite to include the second custom media item.

7. The method of claim 1, wherein the first user comprises a host of the virtual meeting.

8. A system, comprising:
a memory; and
a processing device, coupled to the memory, configured to perform operations comprising:
receiving, at a virtual meeting platform, a first custom media item provided by a first user of a virtual meeting between a plurality of participants, the plurality of participants comprising the first user,
generating a customized virtual meeting invite for the virtual meeting, wherein the customized virtual meeting invite comprises:
the first custom media item provided by the first user, and
a reference to the virtual meeting,
causing the customized virtual meeting invite to be provided to one or more participants of the plurality of participants, and
responsive to obtaining an indication of a participant of the one or more participants interacting with the reference to the virtual meeting of the customized virtual meeting invite, instantiating the virtual meeting.

9. The system of claim 8, wherein the first custom media item comprises a theme.

10. The system of claim 9, wherein the theme comprises a theme that indicates to a recipient of the customized virtual meeting invite an identity of the first user.

11. The system of claim 8, wherein:
the customized virtual meeting invite is configured to be saved to a calendar application of a participant of the one or more participants as a calendar event; and
responsive to the participant interacting with the calendar event, the calendar application displays the first custom media item.

12. The system of claim 8, wherein:
the first custom media item is stored on a cloud storage platform; and
the customized virtual meeting invite comprising the first custom media item includes the customized virtual meeting invite comprising a reference to access the first custom media item in the cloud storage platform.

13. The system of claim 8, wherein the reference to the virtual meeting comprises a link to the virtual meeting.

14. The system of claim 8, further comprising:
receiving, at the virtual meeting platform, a second first custom media item provided by the first user; and
updating the customized virtual meeting invite to include the second first custom media item.

15. The system of claim 8, wherein the first user comprises a host of the virtual meeting.

16. A non-transitory computer-readable storage medium comprising instructions that, when executed by a processing device, cause the processing device to perform operations comprising:
receiving, at a virtual meeting platform, a custom media item provided by a first user of a virtual meeting between a plurality of participants, the plurality of participants comprising the first user;
generating a customized virtual meeting invite for the virtual meeting, wherein the customized virtual meeting invite comprises:
the custom media item provided by the first user, and
a reference to the virtual meeting;
causing the customized virtual meeting invite to be provided to one or more participants of the plurality of participants; and
responsive to obtaining an indication of a participant of the one or more participants interacting with the reference to the virtual meeting of the customized virtual meeting invite, instantiating the virtual meeting.

17. The computer-readable storage medium of claim 16, wherein the custom media item comprises at least one of:
image data;
video data; or
audio data.

18. The computer-readable storage medium of claim 16, wherein the custom media item comprises a theme.

19. The computer-readable storage medium of claim 16, wherein the customized virtual meeting invite comprises at least one of:
a calendar invite file; or
a data file configured to cause a presentation of a notification on a client device.

20. The computer-readable storage medium of claim 16, wherein:
the custom media item is stored on a cloud storage platform; and
the customized virtual meeting invite comprising the custom media item includes the customized virtual meeting invite comprising a reference to access the custom media item in the cloud storage platform.
